(19) United States
(12) Patent Application Publication
(10) Pub. No.: US 2002/0060243 A1
(43) Pub. Date: May 23, 2002

(54) Biometric authentication device for use in mobile telecommunications

(76) Inventors: Martin J. Janiak, Middleton, MA (US); Mark R. Depp, Fitchburg, WI (US); Cathy Schaub, Scottsdale, WI (US); Barry Howe, Middleton, WI (US); Thomas Schenk, Verona, WI (US); Greg Wachter, Sun Prairie, WI (US); Greg Krueger, Jefferson, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/683,051

(22) Filed: Nov. 13, 2001

Related U.S. Application Data
(60) Provisional application No. 60/248,056, filed on Nov. 13, 2000.

(51) Int. Cl. G06K 5/00

(52) U.S. Cl. 235/382

(57) ABSTRACT

A biometric authentication device for use with a telecommunications device such as a wireless phone having memory, processing power and communication capabilities is disclosed. The biometric device includes a fingerprint module having a fingerprint sensor for capturing a user's fingerprint placed onto the fingerprint sensor. The fingerprint module is interconnected and communicates with the telecommunications device. The fingerprint module also includes a portion adapted to receive and read a card containing electronic fingerprint information, such as a smart card. The fingerprint module is capable of determining a match between the user's fingerprint captured from the fingerprint sensor and the electronic fingerprint information stored on the smart card. Determination of the match between the end user captured fingerprint and the stored electronic fingerprint information enables biometric verification or identification of the end user. This information may be transmitted via the interconnected telecommunications device. The biometric device is useful in time and attendance, access and control as well as user identification and verification applications. Application program interface software used with the biometric device permits application specific solutions to be developed for biometric telecommunications.

### CROSS REFERENCE TO RELATED APPLICATIONS

This application claims the benefit of U.S. Provisional Application No. 60/248,056 filed Nov. 13, 2000.

### BACKGROUND OF INVENTION

The present invention relates generally to biometric technology and biometric solutions, and more particularly to a biometric solution that combines a mobile telephone or other telecommunications device with a biometric system that is useful in identification, time-and-attendance and access-and-control applications.

The field of biometrics, or the measuring of a physical characteristic used to recognize the identity or verify the claimed identity of an individual, has emerged as an increasingly reliable methodology for verification (one-to-one) and identification (one-to-many) of individuals. Biometrics has become a very powerful tool in the solving of problems associated with requiring positive identification of individuals.

Live capture biometrics, which is the process of capturing a biometric sample by an interaction between an end user and a biometric system, requires a significant amount of memory, processing power and communication capabilities to quickly and accurately perform the biometric functions assigned. A high level of functionality, and correspondingly, processing power, is required to: read from and write to memory and smart cards; read fingerprint sensors; extract minutia; and compare against smart card or internally stored fingerprint data. Oftentimes, the resultant product may be prohibitively bulky, expensive and complicated so as not to be readily adapted for commercial applications, particularly for those biometric applications that require verification or identification from a variety of locations. Additionally, such devices are not readily adaptable application-to-application, and the entire unit must be reconfigured in order to run the desired biometric application.

Additionally, the use and functionality of cell phones, mobile phones and other telecommunications devices has ramped up dramatically. Increasingly, the portability and widespread use of these devices makes biometric identification of a user of these devices desirable.

Therefore, there exists the need for a portable biometric system that is readily connectable to and uses readily available devices having the requisite memory, processing power and communication capabilities necessary to perform the biometric function for the particular application. Additionally, there exists the need for a biometric solution that can be easily integrated into an application specific software to allow for customized applications of the fingerprint verification and identification technology.

### SUMMARY OF INVENTION

The present invention provides a biometric authentication device and overcomes the aforementioned problems, and provides a biometric authentication device that may be used with a telecommunications device to yield a biometric solution.

In accordance with one aspect of the invention, a biometric device for use with a telecommunications device includes a fingerprint module having fingerprint sensor for reading a fingerprint and generating fingerprint data, and electronic circuitry located within the fingerprint module which is connected to the fingerprint sensor to process the fingerprint data. The fingerprint module may further include a compact flash connector for connecting the fingerprint module and a smart card slot for receiving a smart card.

In accordance with another aspect of the invention, a biometric device for use with telecommunications device and a user of the telecommunications device is disclosed. The biometric device includes a fingerprint module including a fingerprint sensor for reading a fingerprint of the user. The fingerprint module is receptive to and connectable with the telecommunications device to allow electronic communication with the telecommunications device. The fingerprint module includes a portion adapted to receive and read a data card having fingerprint information. The fingerprint module, as well as application software resident in the telecommunications device, is capable of determining a match between the user fingerprint right from the fingerprint sensor and the fingerprint information on the data card.

In another aspect of the invention, a biometric identification module for use with a telecommunications device comprises a housing, and a biometric sensor exposed through the housing for obtaining user biometric data. The biometric identification module also includes a receiving portion receptive to a biometric data storage device having stored biometric data, and electronic processing and storage circuitry disposed within the housing and connected to the biometric sensor. The module also includes an application program interface programmed into the processing and storage circuitry to compare the user biometric data to the stored biometric data.

In another aspect of the invention, a biometric device for use with a telecommunications device includes a fingerprint module, a fingerprint sensor connected to the fingerprint module for generating fingerprint data, and a communication port integral with the fingerprint module. The communication port is in electrical communication with the fingerprint sensor for transmitting the fingerprint data from the fingerprint sensor through the communication port to the telecommunications device.

Various other features, objects and advantages of the present invention will be made apparent from the following detailed description and the drawings.

### BRIEF DESCRIPTION OF DRAWINGS

The drawings illustrate one mode presently contemplated for carrying out the invention.

In the drawings:

FIG. 1 is a perspective exploded view illustrating a biometric system in accordance with the present invention;

FIG. 2 is another perspective view showing the biometric system connected to a telecommunications device;

FIG. 3 shows a partial perspective view of one embodiment of the present invention;

FIG. 4 is a side elevational view of the present invention taken along line 4-4 of FIG. 2;

FIG. 5 is a functional diagram illustrating the functional layer of one embodiment of the present invention; and

FIG. 6 is a functional block diagram illustrating the biometric solution system in accordance with one aspect of the present invention.

### DETAILED DESCRIPTION

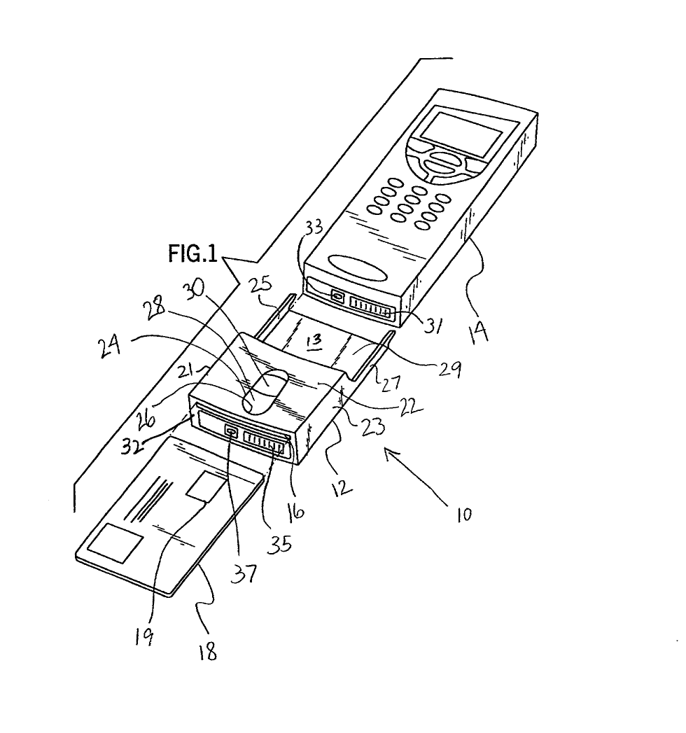

Referring now to FIG. 1, the biometric system of the present invention is shown generally by the numeral 10. The biometric system 10 includes a fingerprint identification module (FIM) or biometric hub 12. FIM 12 is connected to a telecommunications device or wireless phone 14 such that an electronic connection is established. Telecommunications device 14 as used herein includes any type of portable telecommunications device, including cellular phones, satellite phones, personal pocket PCs, wireless phones having PDA capabilities, or other personal electronic devices or telephonic hosts having the requisite power and processing capabilities as contemplated by the present invention. Other biometric solutions may require other telecommunications devices, and such devices are contemplated as being included of the scope of the present invention. One suitable telecommunications device has been the Nokia 9110 Communicator, although any suitable telecommunications device is contemplated by the present invention. Fingerprint identification module 12 interconnects with telecommunications device 14 to form a portable biometric reader. Preferably, the fingerprint identification module 12 connects to the telecommunications device so as not to interfere with normal operation of the telecommunications device. Additionally, if the telecommunications device utilizes a cradle-type device for stability and/or synchronization purposes, the addition of the fingerprint identification module 12 does not interfere with the installation of the telecommunications device 14 into the cradle, or cause tipping of the cradle during operation. Fingerprint identification module 12 may be removed from the telecommunications device when desired.

Fingerprint identification module 12, in a preferred embodiment, includes a slot 16 for receiving a data card 18. Data card 18 may come in any form that is capable of storing fingerprint data for an enrollee. An enrollee is a potential user of the system who has gone through the enrollment process, or the process of collecting biometric samples from a person and storing the biometric samples on the data card for comparison to the end user's biometric sample. Data card 18 may be, for example, an optical card where a single (or multiple) fingerprint image(s) is/are contained within a 2D barcode symbol, such as a PDF 417 patch, or printed on a plastic ID card. This fingerprint image is capable of being optically read from the data card. Data card 18 may also include a memory card that includes a memory chip 19 embedded within the card (chip card). The chip is capable of storing more information than the optical data card, but also permits the writing of transactional data to the chip while the data card is inserted. The data can be downloaded later to another central location for the particular application. The data can then be erased from the memory card, thereby freeing up space for additional information storage. Additionally, the data card may be a smart card, where transactional data can be collected and stored, but it also may be processed and used directly by the smart card, in particular applications. Therefore, a card which is read-only, read-and-write, or read-write-transactional is contemplated by data card 18.

Fingerprint identification module 12 is shown prior to connecting to any host device. FIM 12 includes a front side 32, two sides 21, 23 and cradling portion 13. Cradling portion 13 includes cradling sides 25, 27 connected by back surface 29. FIM 12 includes slot 16 which is shown along an end 32 such that insertion of a data card 18 into slot 16 does not interfere with the coupling of FIM 12 to any host device. Generally, in a preferred embodiment, FIM 12 has a cradle-like appearance, but may take any suitable form such that it may be easily connected with and slidably engageable to a host device. FIM 12 includes a top surface 22 which is at least partially defined by a ridge 24. Ridge 24 defines an inner wall 26 which extends to fingerprint read surface 28. Along read surface 28 is a fingerprint read field or fingerprint sensor 30. Wall 26 may take on shapes other than those specifically identified, such as a semiparabolic or other shape that facilitates user placement of a finger onto fingerprint sensor 30. However, the shape of ridge 24 and wall 26 is important in that it exposes an area on the fingerprint read surface 28 such that a user may place a finger onto fingerprint sensor 30 while facing end 32, for example, while using the telecommunications device or other host device 14 of FIG. 1.

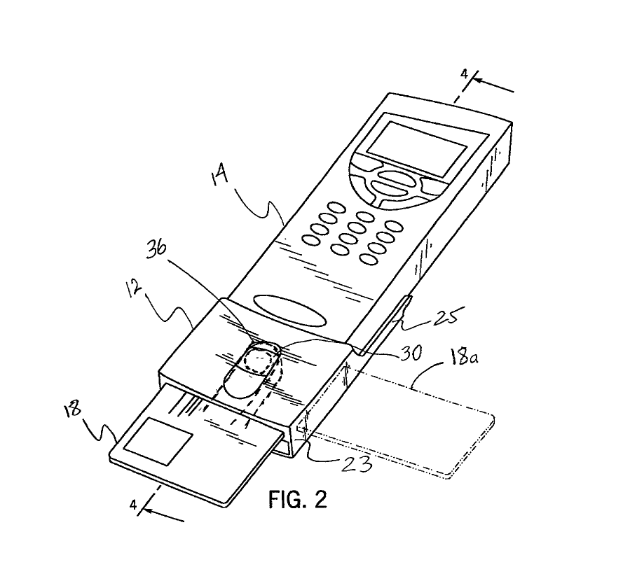

Referring now to FIG. 2, FIM 12 is shown connected to telecommunications device 14 and with data card 18 inserted. FIM 12 is slidably engageable with and removably connectable to telecommunications device 14. When connected, there is an electrical contact established between telecommunications device 14 via its connection ports and the internal connection ports of FIM 12. Telecommunications device 14 slides into FIM 12 and is held secure in part by cradling side 25. Data card 18 may be inserted in a direction that is substantially parallel to the length of the FIM 12. Alternatively, and in some preferred embodiments, insertion slots may be placed so that data card 18 may be inserted into other faces of FIM 12, such as illustrated by data card 18a (in phantom) inserted into side face 23 in a direction that is substantially perpendicular to the length of FIM 12. In some instances, this may prevent data card 18 from interfering with any peripheral connection capabilities of FIM 12 while data card 18a is inserted. In operation, the end user places a finger 36 from which biometric information may be extracted onto fingerprint sensor 30.

Referring now to FIG. 3, FIM 12 is shown connected to telecommunications device 14 and exposing connection ports 35 and 37. Peripheral connection cords 39 and 41, which may be power cords, recharging cords, peripheral connections to other devices, and other connectors, are insertable into peripheral connection ports 35 and 37. These connection ports preferably provide at least the same or similar connectivity to telecommunications device 14 through FIM 12 as though the connections were being directly made to telecommunications device 14. In this way, FIM 12 provides connectivity that would otherwise be lost by connecting to telecommunications device 14.

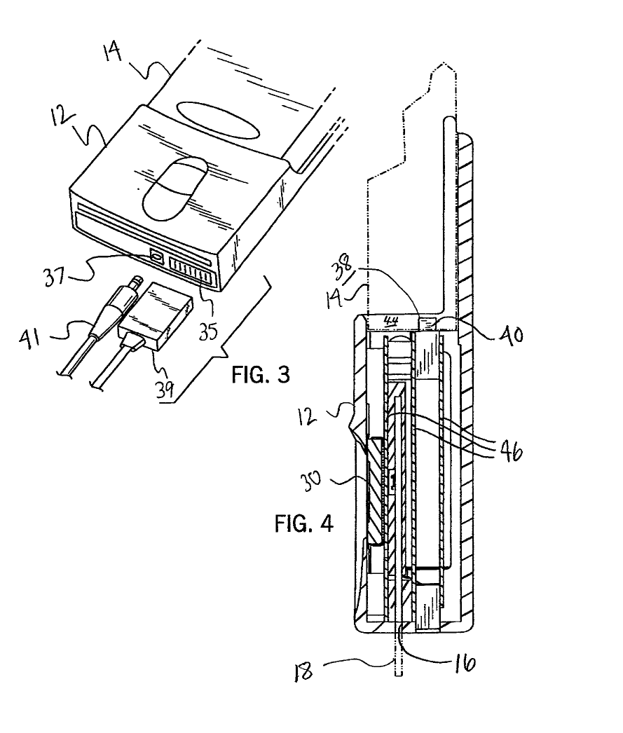

Referring now to FIG. 4, the connection between FIM 12 and telephonic device 14 taken along line 4-4 of FIG. 3 is shown. FIM 12 is connected to telecommunications device 14 at connection portion 44 includes a connection slot 46. FIM 12 includes a hollowed out portion 38 defining an extension connection arm 40 for connection with connector portion 44, which extends from telecommunications device 14. In one embodiment, the connection portion 44 is a compact flash port or slot, or a PCMCIA slot. The preferred connection is with the compact flash (CF) port in a serial connection. This serial communication port connection allows for the utilization of a standard OEM serial port stream driver that is provided as part of a standard embedded operating system to communicate with FIM 12. In one embodiment, power is provided through the compact flash slot connector from the telecommunications device host to fingerprint identification module 12. This decreases the amount of battery power required by the FIM 12, in order to maintain a FIM that is lightweight and that presents the smallest possible footprint (width and length) as possible. Electrical connections between the fingerprint sensor 30, data card 18 and telecommunications device 14 and the system electrical processor and memory are made through circuit boards 46. Circuit boards 46 include electronic circuitry located within the fingerprint module and connected to the fingerprint sensor to process the fingerprint data generated by the fingerprint sensor 30.

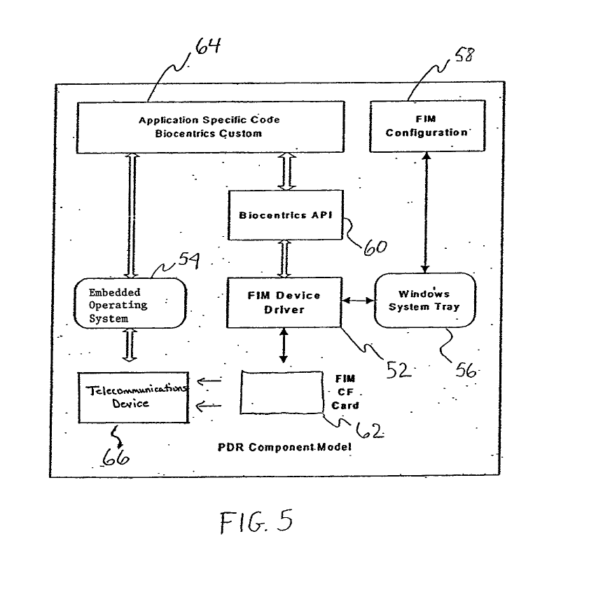

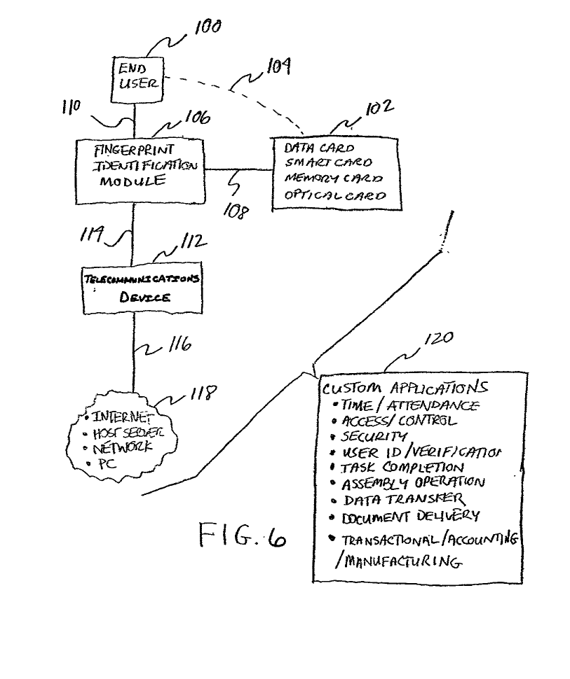

Referring now to FIG. 5, the functional layers for the software contemplated by the present invention are shown. Device driver 52 is an embedded operating level system component that controls the state and access to the components in the fingerprint identification module (12 of Figure It is contemplated that the device driver 52 preferably perform the following functionalities: Providing power and state management of the FIM components in order to maximize data flow, manage a compact flash slot controller; handle raw communications between the fingerprint reader, the data card reader and the telecommunications device; provide the necessary program notification and attempt recovery in the case of fault conditions or exceptions; and present a graphical user interface to the user, via a system tray 56, that allows for configuration and tuning of the FIM components within FIM configuration 58.

Interfacing with FIM device driver 52 is application programming interface (API) 60. APlis a generalized instruction set that will expose the capabilities of the FIM to a developer of custom applications. API 60 is a portable interface that can be preferably ported to and compiled on any platform that offers a C compiler for development. This may include all Windows 9x, Windows CE, Geos and Palm operating system environments. Moreover, it is anticipated that any programming language that can make C type calls can be used to develop applications that utilize API 60. As contemplated by the present invention, the primary FIM functionality offered via the control will be notification of data card 62 insertion into the FIM, reading of the data card 62 data, providing a channel to the fingerprint reader to receive a data stream, extracting fingerprint minutia from the data, and comparing the extracted minutia to that stored data, which is retrieved from the data card 62. Under the umbrella of API 60 and FIM device driver 52 is application specific code Application specific code 64 is programming code that is specific to the application and/or problem being addressed by the biometric solution system. It includes any user interface code, and any business logic that is necessary to reside in telecommunications device 66. The code 64 also supports any data storage and transmission to a host PC, for example. Such code could be available off the shelf, such as a standard chip card enrollment program, a simple custom application that resides only in the portable biometric reader, or thirdintegrators could use the API 60 to construct customized or commercial applications.

Referring now to FIG. 6, a schematic representation of a biometric system in accordance with the present invention is shown as part of what is described as a biometrics anywhere initiative. In the system, an end user 100 goes through the process of enrollment, or the process of collecting biometric samples from a person such that the layer can be compared to a live biometric sample of the end user 100. Such data is stored on a data card 102, which may take many forms, including a smart card capable of reading, writing and computational capabilities, a memory card having read/write capabilities or an optical card having read only data such as a 2-dimensional bar code encoding fingerprint data. In many cases, end user 100 may be in possession of the data card 102. However, it is contemplated by the present invention that the data card may reside at a particular location, with other data cards of similarly enrolled end users such as an end user 100. Given a particular application, it may be desired that the end user maintain possession of data card 102. Regardless, data card 102 represents stored biometric information of end user 100 and therefore there is a biometric link 104 between data card 102 and end user 100. In the present invention, fingerprint identification module 106 receives information stored on data card 102 through connection 108 (for example, by directly reading the data card 102). Alternatively, information contained on data card 102 may be preprogrammed into fingerprint identification module 106, thereby eliminating the need to have a data card available during identification or verification of end user 100. Also, information contained on data card 102 may be wirelessly transmitted via connection 108 to fingerprint identification module 106, for example, by the use of RF ID technology and proximity reading of data card 102 where the actual card need not necessarily be inserted directly into the fingerprint identification module 106 in order to be read. End user 100 provides a live biometric sample 110 to be read by fingerprint identification module 106. Extraction then occurs, which is the process of converting the captured biometric sample into biometric data so that it can be compared to the data on data card 102. Fingerprint identification module 106 works with telecommunications or other host device 112 via connection 114, such that the occurrence of a match or non-match will allow telecommunications device 112 to perform custom specific functionalities. Such information may be transferred via wireless connection 116 to a network 118, that may include the internet, a host server which may be part of a network or simply a resident PC. As noted, biometrics solutions possible with the above components may be fashioned into various custom applications 120, and such varying arrangements, as well as replication of the above model in a wide system may be utilized to effect such customized applications. For example, applications which require time and attendance records may be appropriate. Other custom applications 120 include access and control of facilities as well as security measures to prevent unauthorized entrance. There may be applications 120 that include simple user identification and verification to generate a record of those passing into a given situation, such as a classroom, etc. Additionally, other custom applications 120 may include the completion of a task, where a record may be sent by telecommunications device 112 when a given task has been satisfied, such as an assembly operation, a transfer of data, or delivery of an electronic document. The transfer of data from telecommunications devicemay include other transactional, accounting, manufacturing or other data that is desired to be transmitted at particular times and by particular personnel. Contemplated applications may include:transportation—verification of receipt of goods, and checking of manifest for items delivered; education-identification of students and school personnel anywhere, matching of children and their caregivers when students are leaving school, verifying identity of test-takers in educational settings; aviation—verification of aircraft power plant or airframe repairs, identification of personnel for controlled access, secure luggage pickup and delivery; healthcare—providing proper administration of the correct pharmaceutical to the correct patient in a hospital or clinic setting, and registration of personnel who have access to controlled substances; and banking—tellers may have proof sheet on a telephone, to which is recorded the value of securities they started the day with, the total amount of new securities they took in or paid, and obtain an end of day balance, digitally signed with a fingerprint. The custom applications may be utilized wherever there is a desire for a biometric digital signature, to create a biometrics anywhere solution.

The present invention has been described in terms of the preferred embodiment, and it is recognized that equivalents, alternatives, and modifications, aside from those expressly stated, are possible and within the scope of the appending claims.

1. A biometric device for use with a mobile telecommunications device comprising:
a fingerprint module having a fingerprint sensor for reading a fingerprint and generating fingerprint data; and
electronic circuitry located within the fingerprint module and connected to the fingerprint sensor to process the fingerprint data; and
wherein the biometric device is connectable to and usable with the mobile telecommunications device.

2. A biometric device for use with a mobile telecommunications device comprising:
a fingerprint module having a fingerprint sensor for reading a fingerprint and generating fingerprint data; and
electronic circuitry located within the fingerprint module and connected to the fingerprint sensor to process the fingerprint data;
wherein the fingerprint module further includes a compact flash connection slot; and
wherein the biometric device is connectable to and usable with the mobile telecommunications device through the connection slot.

3. A biometric device for use with a mobile telecommunications device comprising:
a fingerprint module having a fingerprint sensor for reading a fingerprint and generating fingerprint data; and
electronic circuitry located within the fingerprint module and connected to the fingerprint sensor to process the fingerprint data;
wherein the fingerprint module further includes a smart card slot for receiving a smart card; and
wherein the biometric device is connectable to and usable with the mobile telecommunications device.

4. A biometric device for use with a mobile telecommunications device comprising:
a fingerprint module having a fingerprint sensor for reading a fingerprint and generating fingerprint data; and
electronic circuitry located within the fingerprint module and connected to the fingerprint sensor to process the fingerprint data;
wherein the fingerprint module further includes a compact flash connection slot for connecting the fingerprint module and a smart card slot for receiving a smart card; and
wherein the biometric device is connectable to and usable with the mobile telecommunications device.

5. A biometric device for use with a telecommunications device and a user of the telecommunications device comprising:
a fingerprint module including a fingerprint sensor for reading a fingerprint of the user, the fingerprint module receptive to and connectable with the telecommunications device to allow electronic communication with the telecommunications device, wherein the fingerprint module includes a portion adapted to receive and read a data card having fingerprint information, and wherein the fingerprint module is capable of determining a match between the user fingerprint read from the fingerprint sensor and the fingerprint information on the data card.

6. The biometric device of claim 5 wherein the data card is one of a smart card, a memory card and an optical card having an optical bar code for storing the fingerprint information.

7. The biometric device of claim 5 wherein the fingerprint information is stored on a chip located on the data card.

8. The biometric device of claim 5 wherein the telecommunications device is a wireless telephone.

9. The biometric device of claim 5 wherein determination of the match between the user fingerprint and the fingerprint information on the data card enables biometric identification or verification of the user of the telecommunications device.

10. The biometric device of claim 5 wherein the biometric device generates user information, the user information selected from the group consisting of user entry time, user exit time, user check-in time and user attendance.

11. The biometric device of claim 5 wherein the biometric device generates information to selectively grant the user access to a desired location or control of a desired device.

12. The biometric device of claim 5 wherein the biometric device further generates information to identify or verify an identity of the user.

13. A biometric system comprising:
a telecommunications device having at least one application therefor;
a fingerprint module interconnected with the telecommunications device such that the fingerprint module may be utilized in conjunction with the telecommunications device to provide a biometric solution for the at least one application.

14. A fingerprint module for use in a biometric authentication system, the fingerprint module including a fingerprint sensor and wherein the fingerprint module is capable of connection to and operation with a telecommunications device so as to receive biometric information from the fingerprint sensor as part of the biometric authentication system.

15. A portable biometric reader for use with a processing telephonic host comprising:
a fingerprint module having a communication port for communication with the processing telephonic host, the fingerprint module including a fingerprint sensor for reading a fingerprint of the user, the fingerprint module receptive to and connectable with the processing telephonic host to allow electronic communication with the processing telephonic host, wherein the fingerprint module includes a portion adapted to receive and read a data card having fingerprint information, and wherein the fingerprint module is capable of determining a match between the user fingerprint read from the fingerprint sensor and the fingerprint information on the data card.

16. The portable biometric reader of claim 15 wherein the portable biometric reader is capable of utilizing any communication capabilities of the processing telephonic host.

17. A biometric device for use with a telecommunications device comprising:
a biometric module adapted for communication with the telecommunications device, and wherein the biometric module includes an application programming interface software that can be customized to interface with the telecommunications device.

18. A biometric identification module for use with a telecommunications device comprising:
a housing;
a biometric sensor exposed through the housing for obtaining user biometric data;
a receiving portion receptive to a biometric data storage device having stored biometric data;
electronic processing and storage circuitry disposed within the housing and connected to the biometric sensor; and
an application program interface compatible with the telecommunications device programmed into the processing and storage circuitry to compare the user biometric data to the stored biometric data.

19. The biometric identification module of claim 18, wherein the application program interface is compatible with additional programming to obtain application specific output and functionalities for the biometric identification module.

20. The biometric identification module of claim 18, wherein the stored biometric data and the user biometric data are fingerprint data.

21. A biometric solution system for use with a portable telephonic host device comprising:
a biometric identification module comprising:
a housing; and
a biometric sensor exposed through an outer surface of the housing;
a biometric data storage media, the housing further including a receiving portion receptive to the biometric data storage media; and
an application protocol interface programmed into the module,
wherein the application protocol interface is capable of being used in conjunction with an application specific software to provide a customized biometric application solution useable with the portable telephonic host device.

22. The biometric solution system of claim 21, wherein the biometric data storage media is one of a memory card, a smart card and an optical data card.

23. A biometric system comprising:
a fingerprinted identification module for extracting fingerprint data having a communication port; and
a telephonic host device connected to the fingerprint identification module through the communication port, the host device having a storage capacity and processing power to manipulate the fingerprint data extracted from the fingerprint identification module.

24. The biometric system of claim 23 wherein the communication port between the fingerprint identification module and the host device is a serial connection.

25. The biometric system of claim 24 wherein the serial connection is through a compact flash port.

26. The biometric system of claim 23 wherein the serial connection is through a PCMCIA port.

27. The biometric system of claim 23, further comprising a biometric data card insertable into the fingerprint identification module for comparison to data extracted by the fingerprint identification module.

28. A biometric solution system for use with a telecommunications device comprising:
a module for receiving biometric samples, the module connected to the telecommunications device;
a storage media having stored biometric data, the storage media insertable into the module; and
an application program for use by the telecommunications device wherein the application program is specifically designed to operate for a particular biometric solution, the module in operative association with the application program such that a comparison may be made between the biometric samples and the stored biometric data, and wherein the comparison generates an output specific to the application program which may be displayed and transmitted by the telecommunications device as part of the biometric solution.

29. The biometric solution system of claim 28, further including an internet server in electronic communication with the portable solution system for communication to a central data center.

30. The biometric solution system of claim 28, wherein the portable host device is electronically connected to one of a PC, a host server, and a network for collection and storage of the application program output.

31. The biometric solution system of claim 28, wherein the biometric samples are fingerprints.

32. A biometric network comprising:
a plurality of biometric devices, each biometric device comprising:
a fingerprint module including a fingerprint sensor for reading a user fingerprint placed onto the fingerprint sensor, wherein the fingerprint module includes a portion adapted to receive and read a data card having electronic fingerprint information, and wherein the fingerprint module is capable of determining a match between the user fingerprint read from the fingerprint sensor and the electronic fingerprint information; and
a server having a connection to each of the plurality of biometric devices to receive data from each of the plurality of biometric devices.

33. The biometric network of claim 32 wherein the server is connected to the internet.

34. The biometric network of claim 32 wherein the connection is wireless.

35. A biometric device for use with a telephonic device comprising:
a fingerprint module;
a fingerprint sensor connected to the fingerprint module for generating fingerprint data;
a communication port integral with the fingerprint module in electrical communication with the fingerprint sensor for transmitting the fingerprint data from the fingerprint sensor through the communication port to the telephonic device.

36. The biometric device of claim 35 wherein the fingerprint module further includes a slot for receiving a smart card.

37. A biometric device comprising a fingerprint module including a fingerprint read field for reading a user fingerprint placed on the fingerprint read field, the fingerprint module receptive to and connectable with a wireless telephonic device, the fingerprint module including a portion adapted to receive and read a data card wherein the data card includes a chip for storing electronic fingerprint information and the fingerprint module is capable of determining a match between the user fingerprint read from the fingerprint read field and the electronic fingerprint information stored on the chip, and wherein determination of the match enables biometric verification of the user of the wireless telephonic device and wherein the biometric verification of the user may be transmitted via the wireless telephonic device.

38. The biometric device of claim 37 wherein the data card is a memory card.

39. The biometric device of claim 37 wherein the data card is inserted into the fingerprint module.

40. The biometric device of claim 37 wherein the data card is a smart card.

41. The biometric device of claim 37 wherein the data card is an optical card having an optical bar code.

42. The biometric device of claim 37 wherein the wireless telephonic device is a cellular telephone.

43. The biometric device of claim 37 wherein the wireless telephonic device is a communications device.

44. The biometric device of claim 37 wherein the wireless telephonic device is a mobile computer device with telephonic capabilities.

45. The biometric device of claim 37 wherein the wireless device is a combination wireless computer and telephone.

46. The biometric device of claim 37 wherein the biometric device and wireless telephonic device is used in time and attendance applications.

47. The biometric device of claim 37 wherein the biometric device and wireless telephonic device is used in user verification applications.

48. The biometric device of claim 37 wherein the biometric device and wireless telephonic device is used in access and control applications.

49. A biometric device for use with a telecommunications device having connection ports, at least one of the connection ports for connection to a peripheral connector, the biometric device comprising:
a biometric hub having an end that is receptive to the telecommunications device for removable attachment to and electrical communication with the telecommunications device;
wherein the biometric device further includes peripheral connection ports and wherein any peripheral connectors for use with the telecommunications device are capable of being connected to the telecommunications device through the peripheral connection ports of the biometric hub.

50. The biometric device of claim 49 wherein connectivity of the telecommunications device is not reduced when the biometric hub is attached thereto.

51. The biometric device of claim 49 further including a data card for insertion into a data card slot of the biometric hub, and wherein the data card is inserted in a direction substantially parallel to a length of the biometric hub.

52. The biometric device of claim 49 further including a data card for insertion into a data card slot of the biometric hub, and wherein the data card is inserted in a direction substantially perpendicular to a length of the biometric hub.

53. The biometric device of claim 49 wherein the data card slot is located within a front face of the biometric device.

54. The biometric device of claim 49 wherein the data card slot is located within a side face of the biometric hub.

55. The biometric device of claim 49 wherein the peripheral connection ports are capable of receiving telephone power connectors.

56. The biometric device of claim 49 wherein the peripheral connection ports are capable of receiving a recharger connector.

57. The biometric device of claim 49 wherein the telecommunications device is a wireless telephone.

58. The biometric device of claim 49 wherein the biometric hub includes a cradling portion and wherein the telecommunications device is connectable to and slidably engageable with the cradling portion of the biometric hub.
